(19) United States
(12) Patent Application Publication
(10) Pub. No.: US 2018/0329871 A1
(43) Pub. Date: Nov. 15, 2018

(54) Page-Based Navigation for a Dual-Display Device

(71) Applicant: Microsoft Technology Licensing, LLC, Redmond, WA (US)

(72) Inventors: Eduardo SONNINO, Vancouver (CA); Anthony DART, Redmond, WA (US); Nishant SINGHAL, Redmond, WA (US); Ryan Chandler PENDLAY, Bellevue, WA (US); Scott David SCHENONE, Seattle, WA (US); Jason M. NELSON, Redmond, WA (US); March ROGERS, Bothell, WA (US); Jason HARTMAN, Woodinville, WA (US)

(73) Assignee: Microsoft Technology Licensing, LLC, Redmond, WA (US)

(21) Appl. No.: 15/637,759

(22) Filed: Jun. 29, 2017

Related U.S. Application Data
(60) Provisional application No. 62/506,459, filed on May 15, 2017.

(51) Int. Cl. G06F 17/21; G06F 17/30; G06F 9/44; G06F 9/445

(52) U.S. Cl. CPC G06F 17/217; G06F 17/212; G06F 17/30905; G06F 9/4443; G06F 9/445; G06F 17/30274

(57) ABSTRACT

Techniques for page-based navigation for a dual display device are described. In one or more implementations, a journal application maintains multiple different journals. A navigation manager enables navigation through different journals in response to a first set of user gestures, and enables navigation through a sequence of interactive pages of a selected journal in response to a second set of gestures. In one or more implementations, the navigation manager enables navigation forward and backward through the sequence of interactive pages of the journal application using single-page navigation for a dual-display device.

### RELATED APPLICATION

This application claims priority to U.S. Provisional Application No. 62/506,459, filed May 15, 2017, entitled “Page-Based Navigation for a Dual-Display Device”, the disclosure of which is hereby incorporated by reference herein in its entirety.

### BACKGROUND

More and more users are switching from paper-based books and journals to electronic books and journals. Conventionally, electronic book readers are configured to display such electronic books and journals on a single display screen. This can be confusing for users that are used to navigating books and journals which, when opened, include two pages instead of just a single page. Furthermore, it can be difficult to interact with and navigate through the pages of an electronic book or journal displayed on a single screen device.

### SUMMARY

Techniques for page-based navigation for a dual display device are described. In one or more implementations, a journal application maintains multiple different journals. A navigation manager enables navigation through different journals in response to a first set of user gestures, and enables navigation through a sequence of interactive pages of a selected journal in response to a second set of gestures. In one or more implementations, the navigation manager enables navigation forward and backward through the sequence of interactive pages of the journal application using single-page navigation for a dual-display device.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to support techniques described herein.

FIG. 2 illustrates an example of interactive pages displayed on a dual-display device in accordance with one or more implementations.

FIG. 3A illustrates forward single-page navigation techniques for a dual-display device in accordance with one or more implementations.

FIG. 3B illustrates backward single-page navigation techniques for a dual-display device in accordance with one or more implementations.

FIG. 4 illustrates an example environment in which interactive pages and applications are managed in accordance with one or more implementations.

FIG. 5A illustrates an example of managing a journal layer and an application layer on a dual-display client device in accordance with one or more implementations.

FIG. 5B illustrates an additional example of managing a journal layer and an application layer on a dual-display client device in accordance with one or more implementations.

FIG. 5C illustrates an additional example of managing a journal layer and an application layer on a dual-display client device in accordance with one or more implementations.

FIG. 6A illustrates an example of navigating through multiple journals in accordance with one or more implementations.

FIG. 6B illustrates an example of navigating through multiple journals in accordance with one or more implementations.

FIG. 6C illustrates an example of navigating through multiple journals in accordance with one or more implementations.

FIG. 7 is a flow diagram that describes steps in a method for single-page navigation through a journal application in accordance with one or more implementations.

FIG. 8 is a flow diagram that describes steps in a method for navigating through multiple journals of a journal application in accordance with one or more implementations.

FIG. 9 illustrates an example system that includes an example computing device that is representative of one or more computing systems and/or devices that may implement the various techniques described herein.

### DETAILED DESCRIPTION

Techniques for page-based navigation for a dual display device are described. The described techniques may be implemented in a creative environment, such as a journal application, which includes multiple interactive pages on which the user can write, draw, add objects (e.g., pictures or video), and so forth. The techniques are designed to improve the user experience of navigating through a sequence of interactive pages which are displayed on a dual-display device which includes first and second display devices.

In one or more implementations, the journal application can maintain multiple different journals. For example, a user may utilize separate journals for note taking, classes at school, a day planner, a nutrition log, and so forth. In this scenario, a navigation manager enables navigation through different journals in response to a first set of user gestures (e.g., swiping up or down), and enables navigation through pages of a selected journal in response to a second set of gestures (e.g., swiping left or right).

In one or more implementations, the navigation manager enables navigation forward and backward through the interactive pages of the journal using single-page navigation for the dual-display device. As described herein, single-page navigation corresponds to navigating a single page at a time through the interactive pages of the journal application. Consider, for example, that a first interactive page in a sequence of interactive pages is displayed on a left display device of the dual-display device and a second interactive page in the sequence of interactive pages is displayed on a right display device of the dual-display device. In this scenario, in response to user input to navigate forwards in the journal, the navigation manager navigates forward through the journal by causing display of the second interactive page on the left display device and causing display of a next interactive page in the sequence of interactive pages on the right display device. Notably, the page-single-page navigation techniques described herein are different than a traditional “paper” journal which changes two pages at a time (e.g., display of pages 1 and 2 transitions to display of pages 3 and 4 with a page turn). The single-page navigation techniques improve the user experience in a variety of different ways which are discussed in more detail below.

In one or more implementations, the navigation manager is configured to manage the interactive pages of the journal application in a journal layer, and manage applications executed on the device in an application layer that is separate from the journal layer. In some cases, the application layer overlays the journal layer. In this case, the positioning of applications relative to the dual-display device remains fixed during navigation of the interactive pages. However, by implementing single-page navigation, the user can view each interactive page by navigating such that the interactive page is displayed on the display device that is not currently displaying the application.

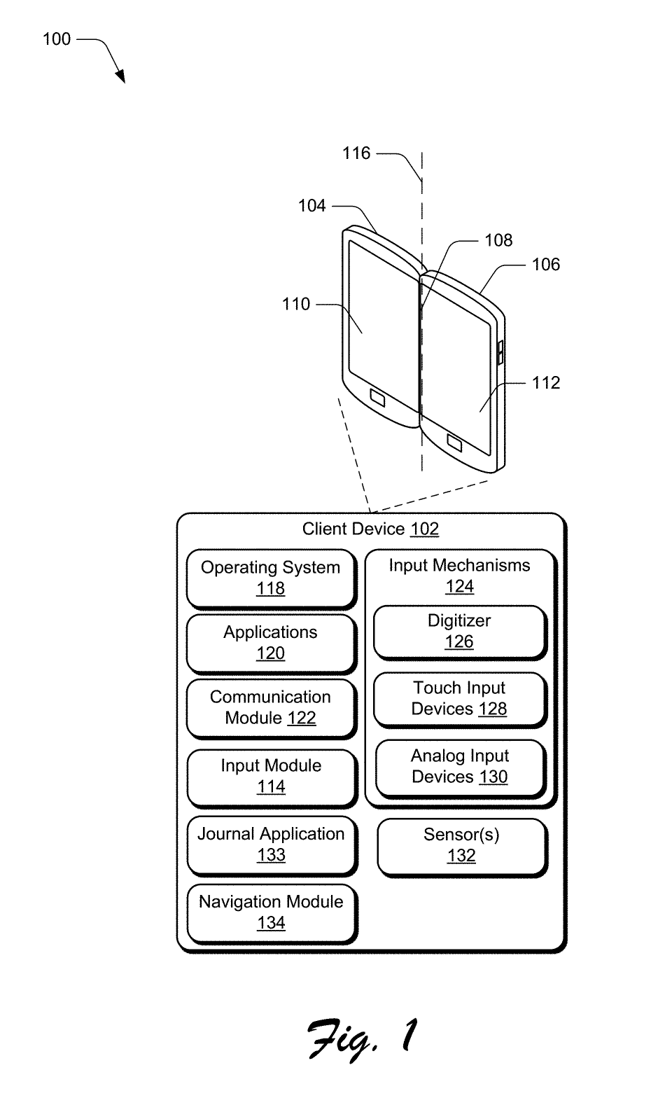

FIG. 1 is an illustration of an environment 100 in an example implementation that is operable to employ techniques described herein. Environment 100 includes a client device 102 which can be configured for mobile use, such as a mobile phone, a tablet computer, a wearable device, a handheld gaming device, a media player, and so on. In this example, the client device 102 is implemented as a “dual-display” device, and includes a display device 104 and a display device 106 that are connected to one another by a hinge 108. The display device 104 includes a touch surface 110, and the display device 106 includes a touch surface 112. The client device 102 also includes an input module 114 configured to process input received via one of the touch surfaces 110, 112 and/or via the hinge 108. While some of the techniques discussed herein will be described with reference to a dual-display device, it is to be appreciated that in some cases the techniques may also be implemented on a single-screen device, such as a mobile phone, tablet computer, media player, laptop computer, desktop computer, and so forth. In addition, the hinge 108 may allow the display devices 104 and 106 to fold back on each other to provide a “single display” device. As such, the techniques described herein may be designed to function whether the user is operating in a two-display mode or a single-display mode. In addition, while the dual display device is illustrated with a hinge in this example, it is to be appreciated that in some cases the techniques may be implemented in single display, dual-display, or multi-display devices without the hinge.

The hinge 108 is configured to rotationally move about a longitudinal axis 116 of the hinge 108 to allow an angle between the display devices 104, 106 to change. In this way, the hinge 108 allows the display devices 104, 106 to be connected to one another yet be oriented at different angles and/or planar orientations relative to each other. In at least some implementations, the touch surfaces 110, 112 may represent different portions of a single integrated and continuous display surface that can be bent along the hinge 108.

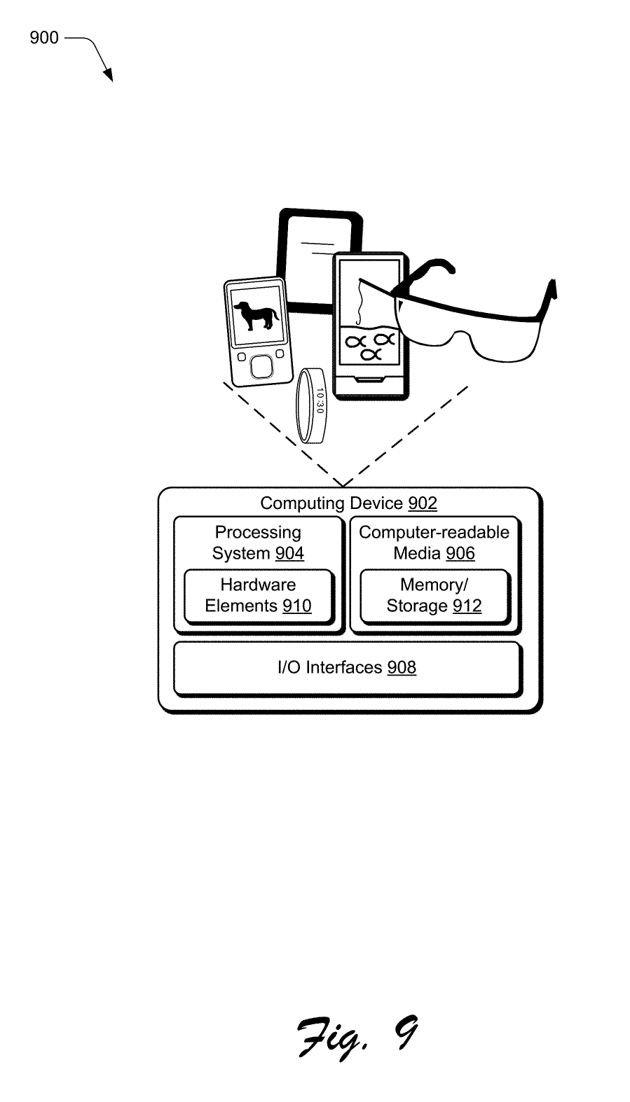

While implementations presented herein are discussed in the context of a mobile device, it is to be appreciated that various other types and form factors of devices may be utilized in accordance with the claimed implementations. Thus, the client device 102 may range from full resource devices with substantial memory and processor resources, to a low-resource device with limited memory and/or processing resources. An example implementation of the client device 102 is discussed below with reference to FIG. 9.

The client device 102 includes a variety of different functionalities that enable various activities and tasks to be performed. For instance, the client device 102 includes an operating system 118, applications 120, and a communication module 122. Generally, the operating system 118 is representative of functionality for abstracting various system components of the client device 102, such as hardware, kernel-level modules and services, and so forth. The operating system 118, for instance, can abstract various components (e.g., hardware, software, and firmware) of the client device 102 to enable interaction between the components and applications running on the client device 102.

The applications 120 are representative of functionality for performing different tasks via the client device 102. In one particular implementation, the applications 120 represent a web browser, web platform, or other application that can be leveraged to browse websites over a network.

The communication module 122 is representative of functionality for enabling the client device 102 to communicate over wired and/or wireless connections. For instance, the communication module 122 represents hardware and logic for communicating data via a variety of different wired and/or wireless technologies and protocols.

According to various implementations, the display devices 104, 106 generally represent functionality for visual output for the client device 102. Additionally, the display devices 104, 106 represent functionality for receiving various types of input, such as touch input, stylus input, touchless proximity input, and so forth via one or more of the touch surfaces 110, 112, which can be used as visual output portions of the display devices 104, 106. The input module 114 is representative of functionality to enable the client device 102 to receive input (e.g., via input mechanisms 124) and to process and route the input in various ways.

The input mechanisms 124 generally represent different functionalities for receiving input to the client device 102, and include a digitizer 126, touch input devices 128, and analog input devices 130. Examples of the input mechanisms 124 include gesture-sensitive sensors and devices (e.g., such as touch-based sensors), a stylus, a touch pad, accelerometers, a microphone with accompanying voice recognition software, and so forth. The input mechanisms 124 may be separate or integral with the display devices 104, 106; integral examples include gesture-sensitive displays with integrated touch-sensitive sensors.

The digitizer 126 represents functionality for converting various types of input to the display devices 104, 106, the touch input devices 128, and the analog input devices 130 into digital data that can be used by the client device 102 in various ways. The analog input devices 130 represent hardware mechanisms (e.g., the hinge 108) that are usable to generate different physical quantities that represent data. For instance, the hinge 108 represents a mechanism that can be leveraged to generate input data by measurement of a physical variable, such as hinge angle of the hinge 108. One or more sensors 132, for example, can measure the hinge angle, and the digitizer 126 can convert such measurements into digital data usable by the client device 102 to perform operations to content displayed via the display devices 104, 106.

Generally, the sensors 132 represent functionality for detecting different input signals received by the client device 102. For example, the sensors 132 can include one or more hinge sensors configured to detect a hinge angle between the display devices 104, 106. Additionally, the sensors 132 can include grip sensors, such as touch sensors, configured to detect how a user is holding the client device 102. Accordingly, a variety of different sensors 132 can be implemented to detect various different types of digital and/or analog input. These and other aspects are discussed in further detail below.

In one particular implementation, the applications 120 include a journal application 133 which provides an interactive canvas representative of pages of a journal. For example, a first interactive page of a sequence of interactive pages of the journal can be presented on display device 104 while a second interactive page of the sequence of interactive pages is presented on display device 106. The user can then write and draw on the interactive canvas, as well as insert and/or manipulate various different objects, such as pictures, videos, audio files, and so forth. While many implementations discussed herein may be discussed with reference to a journal application, it is to be appreciated that these techniques may also be implemented in other environments, such as an electronic book application, an electronic magazine or newspaper application, and so forth.

In at least some implementations, the journal application 133 includes or otherwise make use of a navigation manager 134. The navigation manager 134, for example, for example, represents a standalone application. In other implementations, the navigation manager 134 is included as part of another application or system software, such as the operating system 118. Generally, the navigation manager 134 is configured to enable navigation through interactive pages of the journal on the dual-display device. Further discussion of this and other features is provided below.

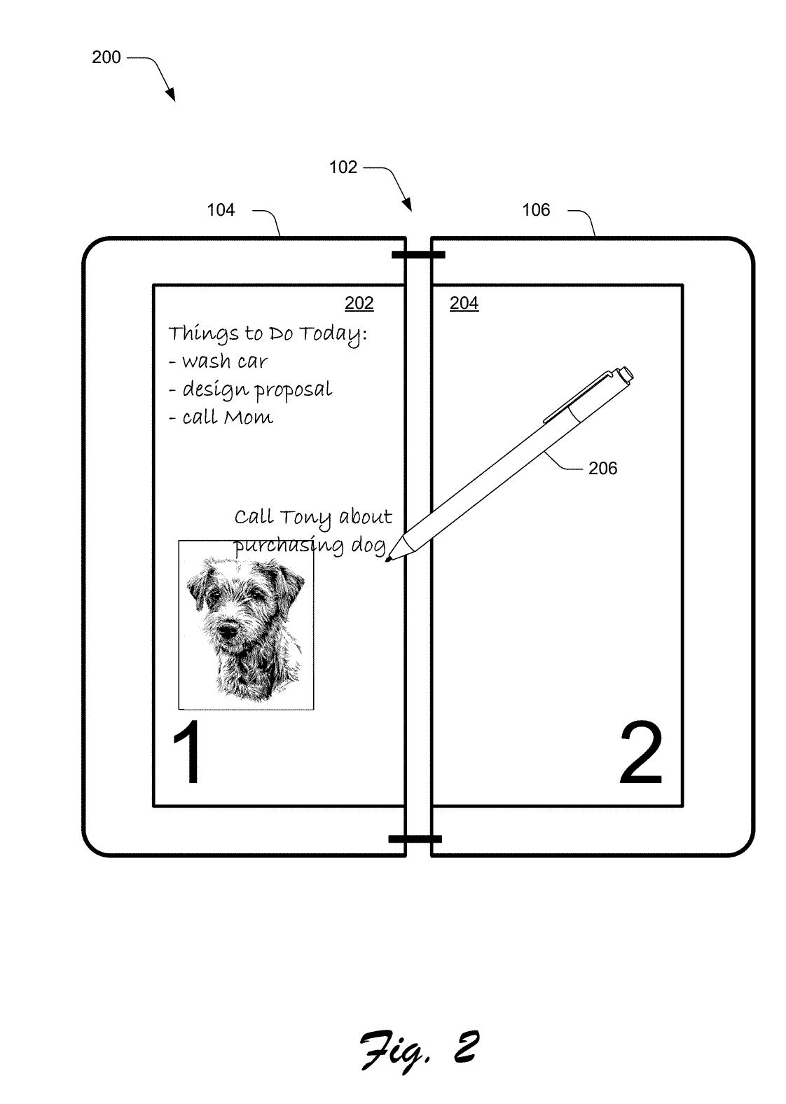

FIG. 2 illustrates an example 200 of interactive pages displayed on a dual-display device in accordance with one or more implementations.

In example 200, a dual-display client device 102 displays interactive pages 202 and 204 of journal application 133 on display devices 104 and 106, respectively. However, as described throughout, in other cases the interactive pages may be presented on a “single-display” device and/or associated with a different type of application, such as an electronic book application. The journal application 133 enables the user to take notes and/or draw on interactive pages 202 and 204 using an input device, such as a stylus 206 or the user's finger. In this example, on interactive page 202, the user has written a list of “things to do today” and a note “call tong about purchasing dog” proximate an image of a dog.

In one or more implementations, the journal application 133 can maintain multiple different journals or other media types (e.g., books or magazines). For example, a user may utilize separate journals for note taking, classes at school, a day planner, a nutrition log, and so forth. In this scenario, a navigation manager enables navigation through different journals in response to a first set of user gestures (e.g., swiping up or down), and enables navigation through pages of a selected journal in response to a second set of gestures (e.g., swiping left or right).

In one or more implementations, navigation manager 134 enables navigation forwards and backwards through the interactive pages using “single-page” navigation for the dual-display client device 102. As described herein, single-page navigation corresponds to navigating a single page at a time through the interactive pages of the journal application. Notably, the single-page navigation described herein is different than a traditional “paper” journal which changes two pages at a time (e.g., display of pages 1 and 2 transitions to display of pages 3 and 4 with a page turn).

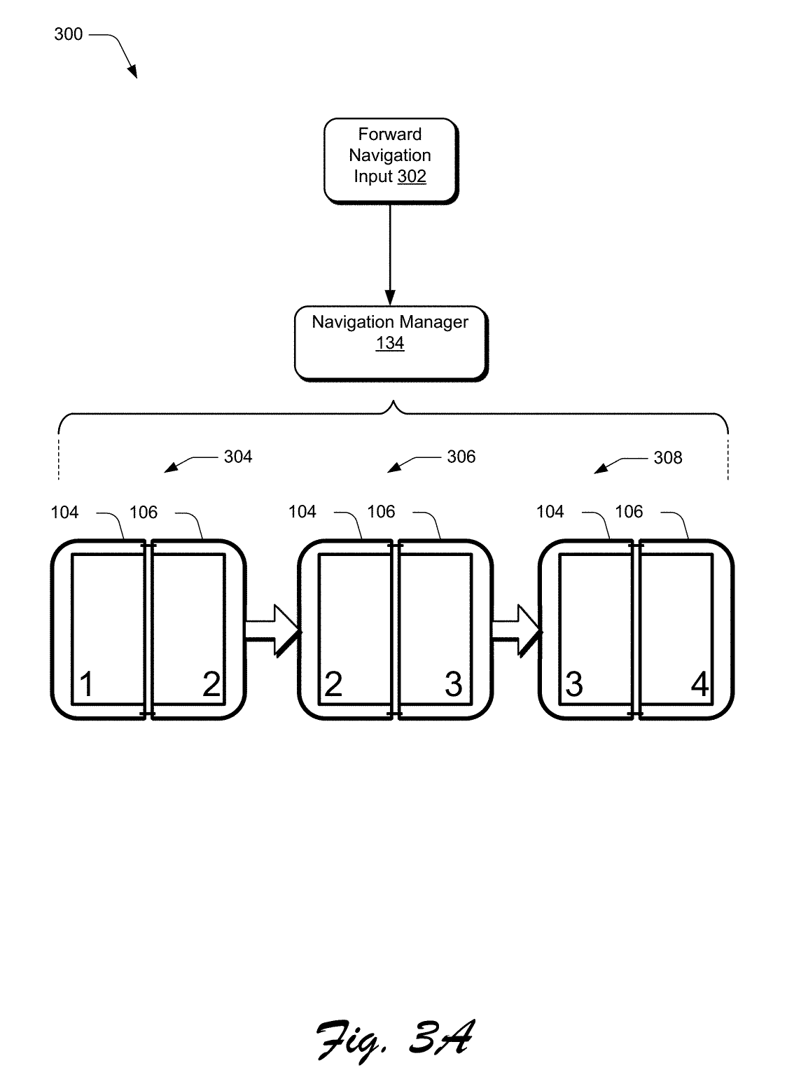

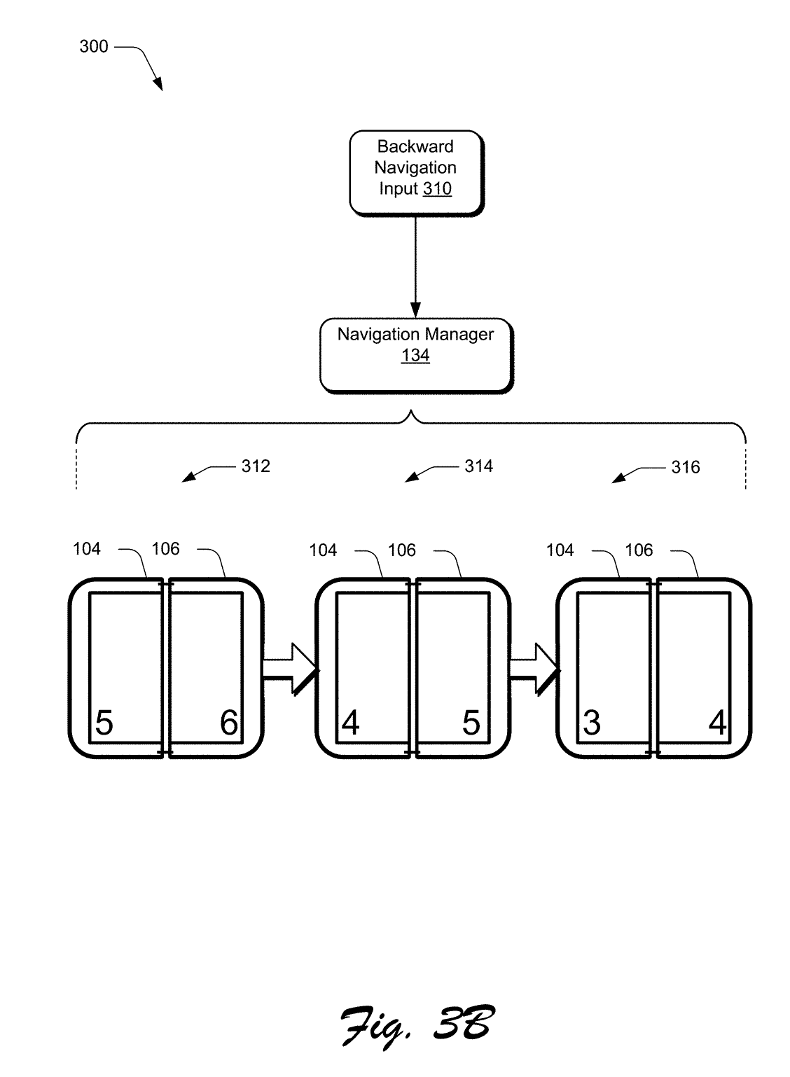

As an example, consider FIGS. 3A and 3B which illustrate forward and backward single-page navigation techniques for a dual-display device in accordance with one or more implementations.

In FIG. 3A, navigation manager 134 receives forward navigation input 302 to scroll forward through a journal application 133. The forward navigation input 302 can be received in a variety of different ways. In one or more implementations, to navigate forward through journal application 133, the user can swipe to the left on the right display device 106 of dual-display client device 102 (e.g., using a stylus or the user's finger). As another example, the user can initiate a page turn by tapping or selecting a page turn icon displayed on one of the display device, or by tapping or selecting a particular area of the display device. For example, user input to the bottom right corner of the right display device 106 may cause navigation forward through the interactive pages while user input to the bottom left corner of the left display device 104 may cause backward navigation through the interactive pages.

In response to the forward navigation input 302, the navigation manager 134 navigates forward through the interactive pages of journal application 133 using single-page navigation. For example, initially at 304, a first interactive page (“page 1”) in a sequence of interactive pages of the journal application is displayed by left display device 104 and a second interactive page (“page 2”) in the sequence of interactive pages of the journal application is displayed by right display device 106. As described herein, the term “first interactive page” and “second interactive page” may correspond to any two sequential pages in the journal application, such that the first interactive page corresponds to a page immediately preceding the second interactive page in the sequence of interactive pages.

At 306, in response to forward navigation input 302, navigation manager 134 navigates forward through the interactive pages by causing display of the second interactive page on left display device 104 and causing display of a next interactive page (“page 3”) in the sequence of interactive pages on right display device 106. Thus, in forward navigation scenarios, the first interactive page is removed from the display devices, the second interactive page is transitioned from the second display device to the first display device, and the next page is displayed by the second display device. As described herein, the term “next page” corresponds to a new interactive page that was not previously displayed and is positioned immediately after the displayed pages in the sequence of interactive pages, whereas the term “previous page” corresponds to a new interactive page that was not previously displayed and is positioned immediately preceding the displayed pages in the sequence of interactive pages. At 308, in response to additional forward navigation input 302, navigation manager 134 navigates forward through the interactive pages by causing display of page 3 on left display device 104 and causing display of a next interactive page (“page 4”) on right display device 106.

In FIG. 3B, navigation manager 134 receives backward navigation input 310 to scroll backwards through a journal application 133. The backward navigation input 310 can be received in a variety of different ways. In one or more implementations, to navigate backwards through journal application 133, the user can swipe to the right on the left display device 104 of dual-display client device 102 (e.g., using a stylus or the user's finger). As another example, the user can tap the bottom left corner of the left display device 104 in order to navigate forward through the interactive pages.

In response to the backward navigation input 310, the navigation manager 134 navigates backward through the interactive pages of journal application 133 using single-page navigation. For example, initially at 312, a first interactive page (“page 5) in a sequence of interactive pages of the journal application is displayed by left display device 104 and a second interactive page (“page 6”) in the sequence of interactive pages of the journal application is displayed by right display device 106.

At 314, in response to backward navigation input 310, navigation manager 134 navigates backward through the interactive pages by causing display of the first interactive page (“page 5”) in the sequence of interactive pages on right display device 106 and causing display of a previous interactive page (“page 4”) in the sequence of interactive pages on left display device 104. Thus, in backward navigation scenarios, the second interactive page is removed from the display devices, the first interactive page is transitioned from the first display device to the second display device, and the previous page is displayed by the first display device. Similarly, at 316, in response to additional backward navigation input 310, navigation manager 134 navigates backward through the interactive pages by causing display of a previous interactive page (“page 3) on left display device 104 and causing display of interactive page 4 on right display device 106.

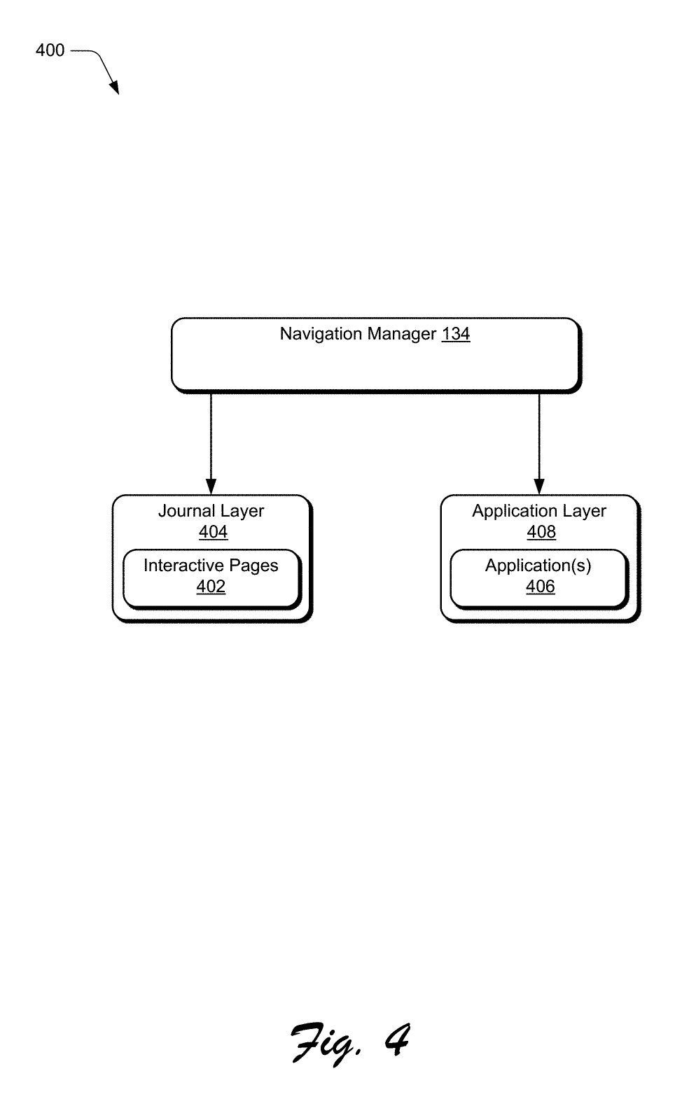

FIG. 4 illustrates an example environment 400 in which interactive pages and applications are managed in accordance with one or more implementations. In this example, navigation manager 134 manages interactive pages 402 of journal application 133 in a journal layer 404, and manages applications 406 executed on client device 102 in an application layer 408 which is separate from the journal layer 404. In one or more implementations, navigation manager 134 manages the application layer 408 to overlay the journal layer 404.

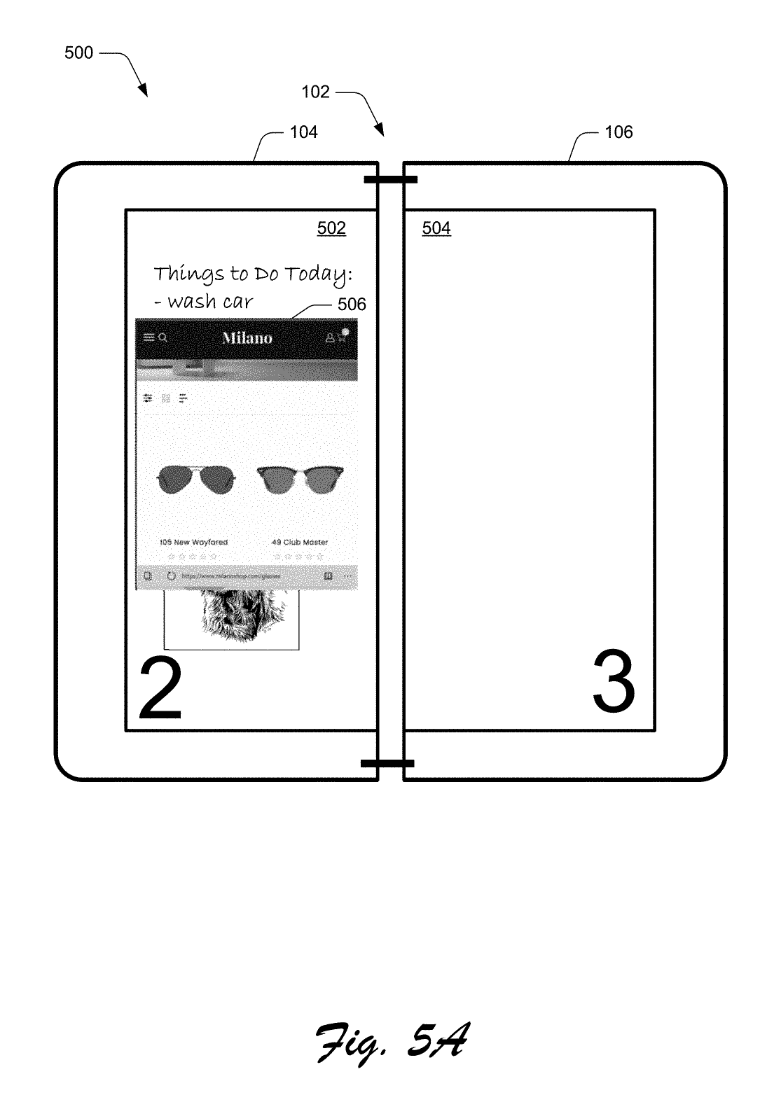

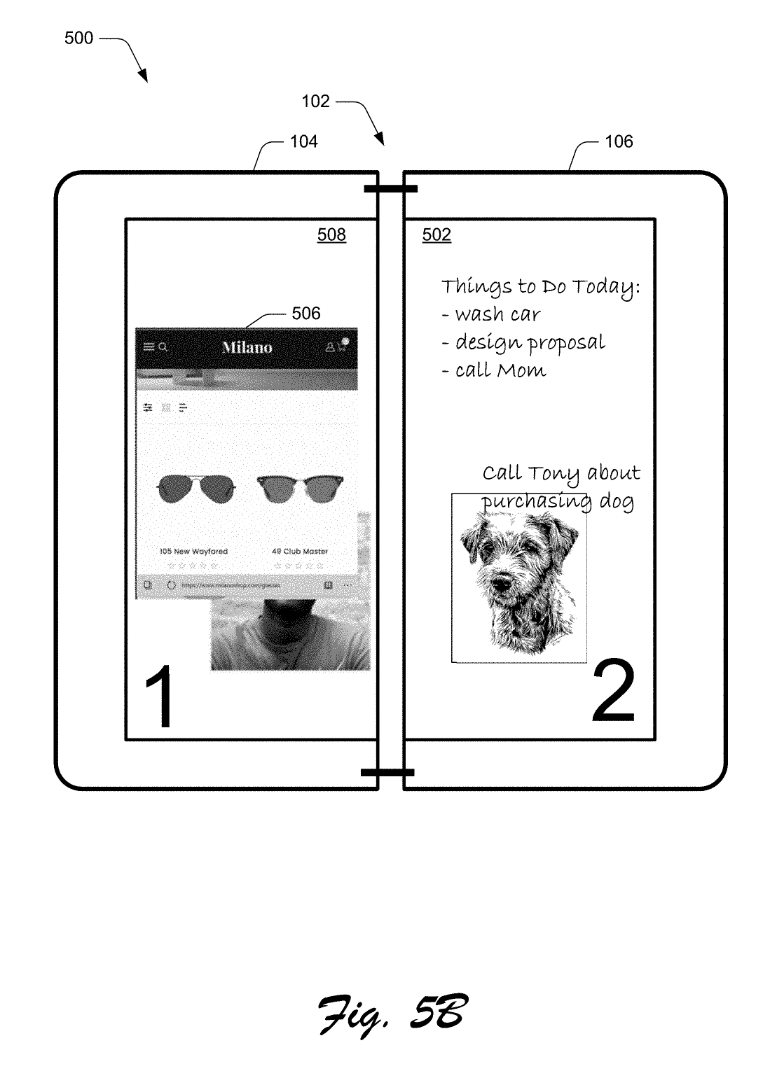

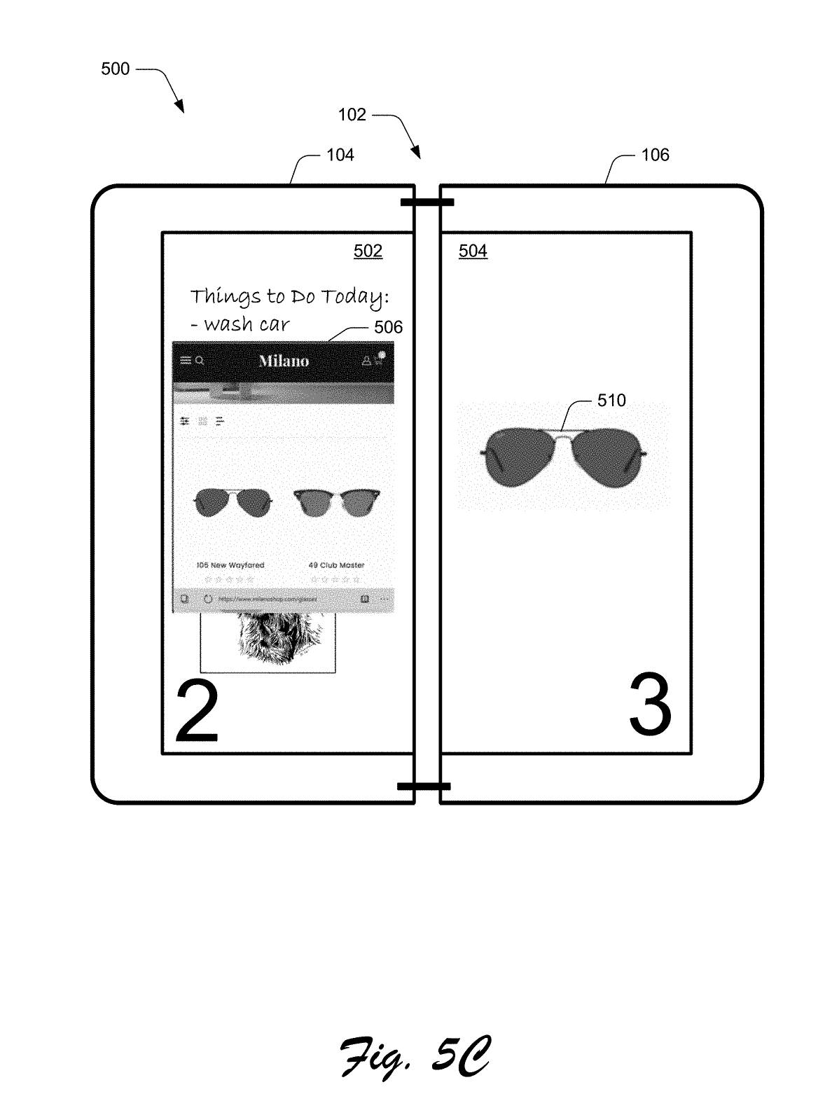

As an example, consider FIGS. 5A to 5C which illustrate examples 500 of managing a journal layer and an application layer on a dual-display client device in accordance with one or more implementations. In FIG. 5A, a dual-display client device 102 displays a second page 502 in a sequence of interactive pages of journal application 133 on a left display device 104, and displays a third page 504 in a sequence of interactive pages of journal application 133 on a right display device 106.

In this example, an application 506 corresponding to a web browser has been launched on device 102. Navigation manager 134 manages interactive pages 502 and 504 in journal layer 404, and manages application 506 in an application layer that overlays the journal layer. For instance, as seen in FIG. 5A, the display of application 506 partially obstructs the content of interactive page 502.

In one or more implementations, navigation manager 134 causes the positioning of applications 406 to remain fixed relative to the display devices 104 or 106 of the dual-display device, even as the user navigates through the journal. For example, in FIG. 5B, the user navigates backward through the journal application 133, causing a first page 508 of the journal application 133 to be displayed on left display device 104 and the second page 502 of the journal application 133 to be displayed on right display device 106. Even though the interactive pages have moved, the application 506 remains at a fixed position on left display device 104. Notably, the single-page navigation techniques employed by navigation manager 134 enables the user to manipulate the journal to display pages on the display device 106 such that the pages are not obstructed. For instance, while second page 502 was obstructed in FIG. 5A, it is now visible in FIG. 5B by virtue of the backward navigation.

In one or more implementations, the navigation manager 134 enables an object contained in an application 406 to be copied directly to an interactive pages 402 in the journal layer 404. For example, in FIG. 5C the user has dragged a picture of sunglasses from the application 506 to interactive page 504, thereby causing the picture of the sunglasses to be integrated into interactive page 504 as an object 510. Notably, object 510 is fixed to interactive page 504, such that if the user navigates through the journal, the object 510 will move with the interactive page 504. In one or more implementations, object 510 contains metadata linking back to the original location. For example, object 510 can include a URL linking back to the website from which the object 510 was copied. In this case, the object 510 can be selected in order to cause the web browser to transition to the website associated with the object 510.

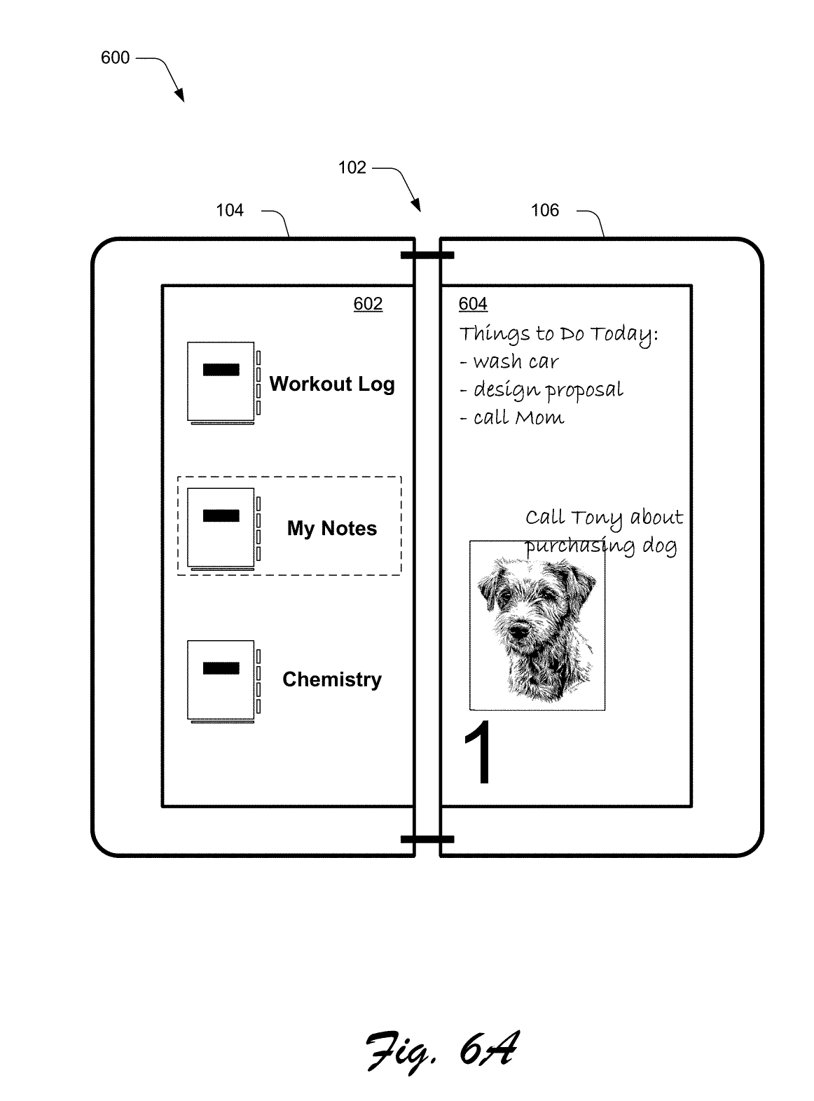

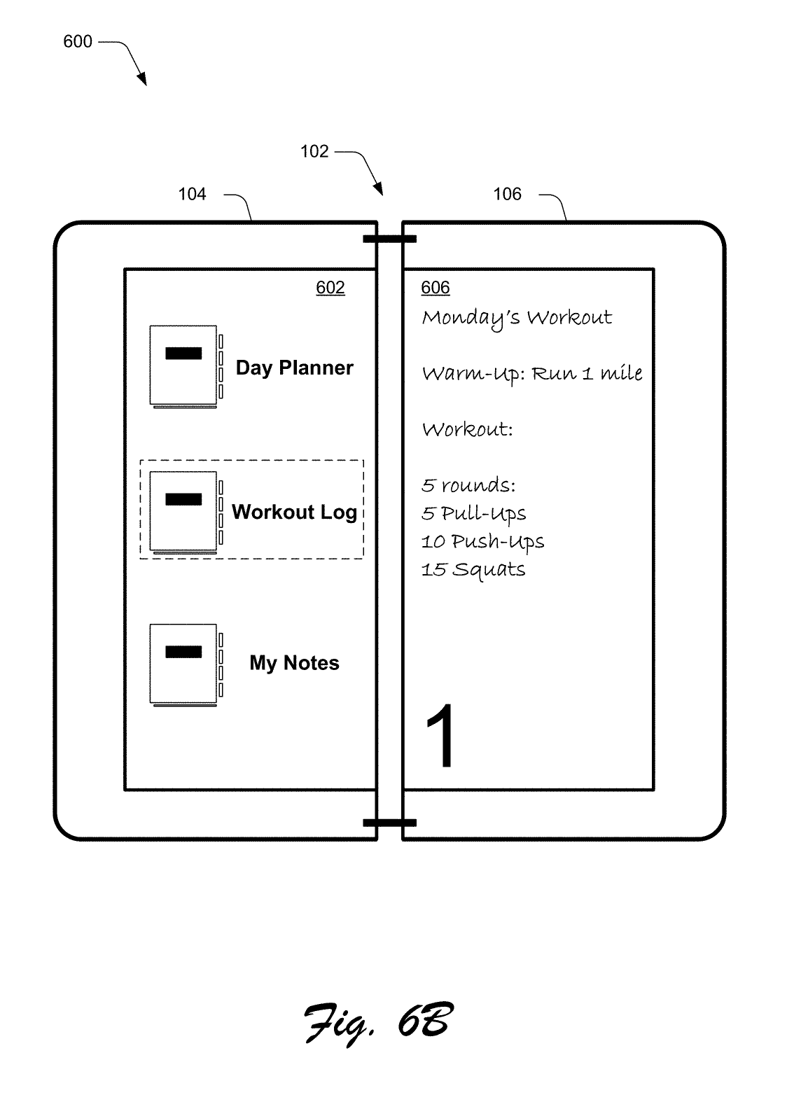

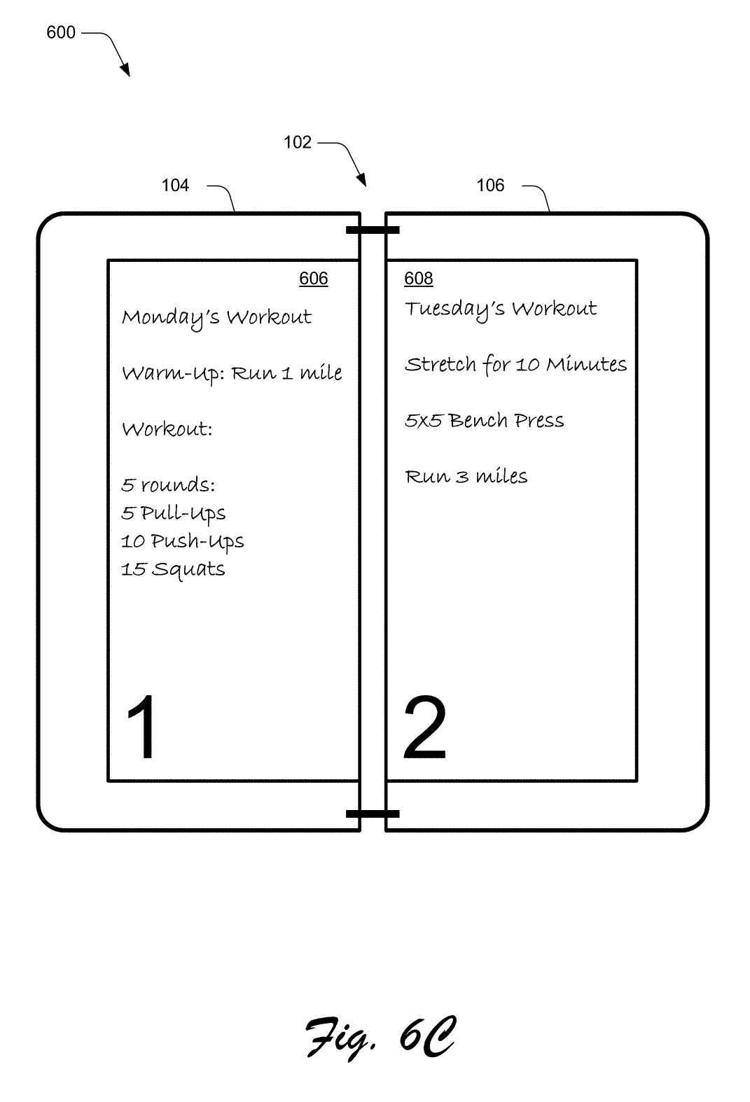

FIGS. 6A to 6C illustrate examples 600 of navigating through multiple journals in accordance with one or more implementations.

In FIG. 6A, a navigation manager 134 displays a journal navigation menu 602 on display device 104 of dual-display client device 102. The journal navigation menu 602 includes selectable representations of multiple journals of journal application 133. In this example, a middle portion of the journal navigation menu 602 displays a selected journal representation, a top portion of the journal navigation menu 602 displays a next journal representation, and a bottom portion of the journal navigation menu 602 displays a previous journal representation. In this example, the selected journal corresponds to a “My Notes” journal, the next journal corresponds to a “Workout Log” journal, while the previous journal corresponds to a “Chemistry” journal. Of course it is to be appreciated that different arrangements of journal representations are contemplated.

While the navigation menu 602 is displayed on the first display device 104, the navigation manager 134 causes display of an interactive page 604 of the selected journal on the second display device 106. In this case, the user has selected the “My Notes” journal, which causes display of a first page (or most recently accessed page) of the “My Notes” journal, on which the user has written a list of “things to do today” and a note “call tong about purchasing dog” proximate an image of a dog. In this example, the journal navigation menu 602 is displayed on the left display device 104 of the dual-display device 102, while the interactive page 604 of the selected journal is displayed on the right display device 106. However, in other implementations the interactive page of the selected journal can be displayed on the left display device, while the journal navigation menu is displayed on the right display device.

Navigation manager 134 enables navigation through the selectable representations of the journals via user input to the journal navigation menu 602. In order to navigate to the next or previous journal, the user can swipe up or down on the journal navigation menu 602, or select one of the journal representations.

For example, in order to navigate to the next journal, which in this example corresponds to the Workout Log journal, the user can select the journal representation corresponding to the Workout Log, or swipe down on the journal navigation menu 602. In response to user input to navigate to the next journal, the navigation manager 134 scrolls the journal representations on the journal navigation menu to display the next journal as the selected journal, and causes display of an interactive page of the newly selected journal on the other display device.

In FIG. 6B, for example, the user has selected the Workout Log journal representation by scrolling down on the journal navigation menu 602 or by touching the representation of the Workout Log journal with a stylus or a finger. In response to the user input, navigation manager 134 scrolls the journal navigation menu 602 to display the Workout Log journal as the selected journal, and causes display of a first interactive page 606 of the Workout Log journal on the display device 106. In this example, the first page of the Workout Log journal includes notes for the user's “Monday Workout”. The navigation manager 134 also moves the “My Notes” journal downward to the previous journal portion of the journal navigation menu 602, and causes display of a new journal representation for a “Day Planner” journal in the next journal portion of the journal navigation menu 602.

The navigation manager 134 enables navigation through interactive pages of the selected journal using the single-page navigation techniques discussed throughout. For instance, user input to navigate to a next interactive page of the journal application 133 causes the interactive page of the selected journal to replace the journal navigation menu 602 on the left display device 104 and causes the next interactive page of the journal application 133 to be displayed on the right display device 106. In FIG. 6C, for example, the user has provided user input to navigate to a next interactive page 608 of the Workout Log journal, such as by swiping left on the first interactive page 606 of the Workout Log journal. In response, the navigation manager 134 replaces the journal navigation menu 602 displayed on the left display device 104 with the first interactive page 606 of the Workout Log journal that was previously displayed on the right display device 106. In addition, the navigation manager 134 causes display of a second interactive page 608 of the Workout Log journal on the right display device 106.

Thus, the navigation manager 134 enables navigation through the selectable representations of the multiple journals in the journal navigation menu 602 responsive to a first set of user gestures (e.g., swiping up or down), and enables navigation through interactive pages of a selected journal in response to a second set of gestures (e.g., swiping left or right). The navigation manager 134 may enable the user to access the journal navigation menu 602 at any time, such as by displaying the navigation menu in response to the user swiping up or down on the display device or by clicking a button on a stylus. Thus, the navigation manager 134 enables the user to quickly and easily switch between multiple different journals maintained by the journal application 133.

The following discussion describes some example procedures in accordance with one or more implementations. The example procedures may be employed in the environment 100 of FIG. 1, the system 900 of FIG. 9, and/or any other suitable environment. The procedures, for instance, represent example procedures for implementation of the scenarios described above. In at least some implementations, the steps described for the various procedures can be implemented automatically and independent of user interaction.

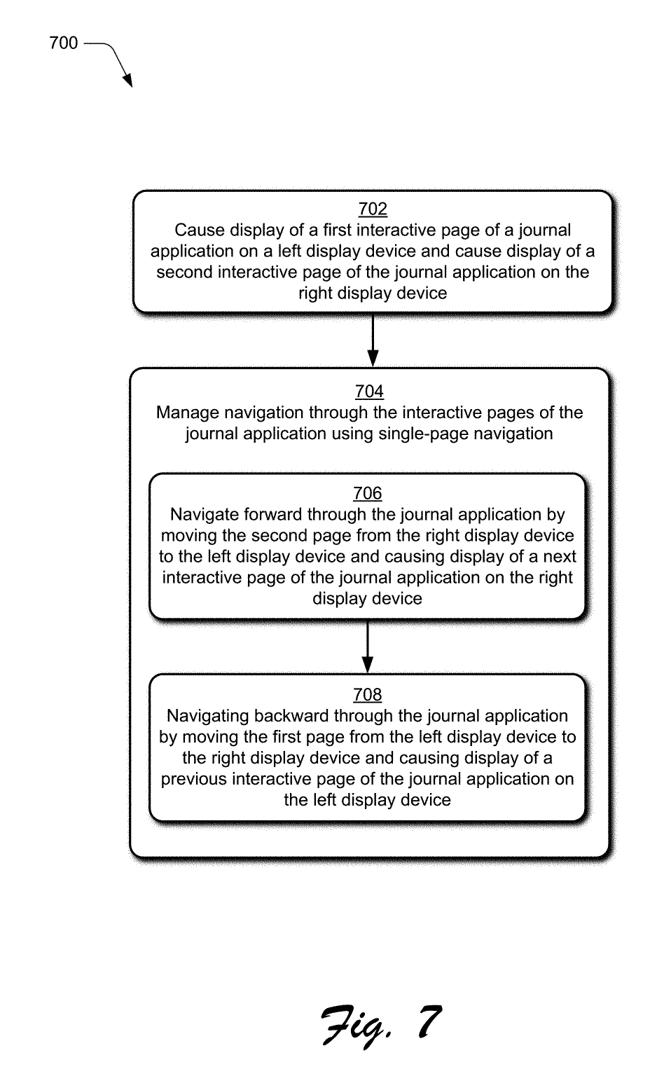

FIG. 7 is a flow diagram that describes steps in a method 700 for single-page navigation through a journal application in accordance with one or more implementations.

At 702, a first interactive page in a sequence of interactive pages of a journal application is displayed on a left display device and a second interactive page in the sequence of interactive pages of the journal application is displayed on the right display device. For example, a first interactive page of journal application 133 is displayed on left display device 104 of a dual-display client device 102, and a second interactive page of a journal application 133 is displayed on right display device 106 of the dual display client device 102.

At 704, navigation through the interactive pages of the journal application is managed using single-page navigation. For example, at 706, forward navigation through the journal application occurs by moving the second interactive page in the sequence of interactive pages from the right display device to the left display device and causing display of a next interactive page in the sequence of interactive pages of the journal application on the right display device. Similarly, at 708, backward navigation through the journal application occurs by moving the first interactive page in the sequence of interactive pages from the left display device to the right display device and causing display of a previous interactive page in the sequence of interactive pages of the journal application on the left display device.

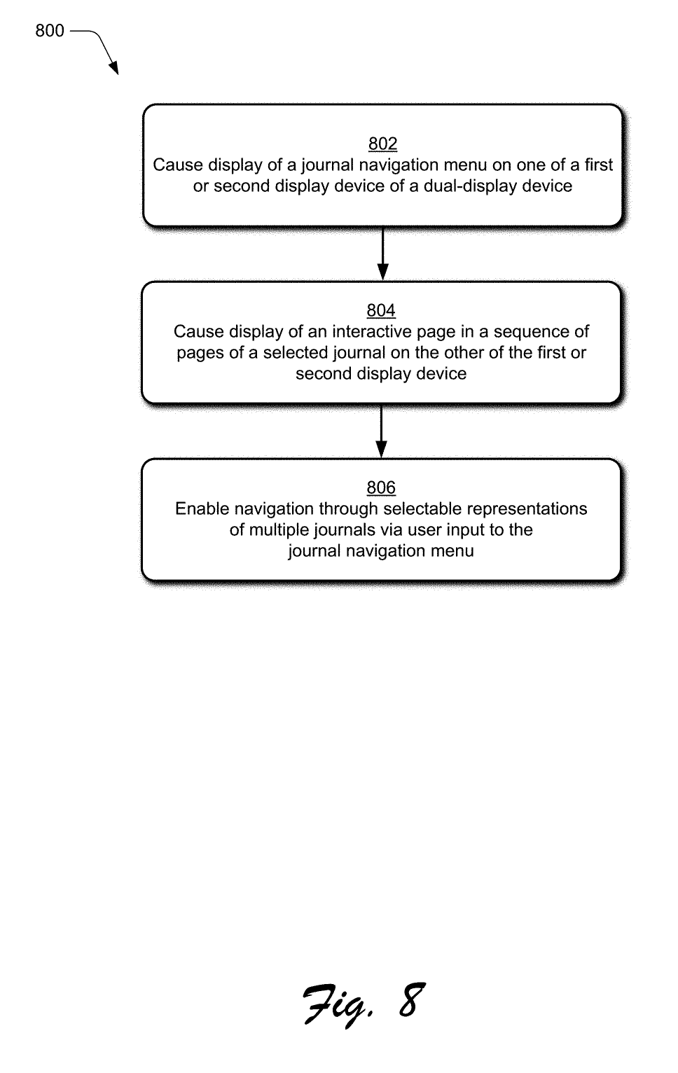

FIG. 8 is a flow diagram that describes steps in a method 800 for navigating through multiple journals of a journal application in accordance with one or more implementations.

At 802, a journal navigation menu is displayed on one of a first or second display device of a dual-display device. For example, a navigation manager 134 displays a journal navigation menu 602 on display device 104 of dual-display client device 102. The journal navigation menu 602 includes selectable representations of multiple journals of journal application 133. For example, a middle portion of the journal navigation menu 602 displays a selected journal representation, a top portion of the journal navigation menu 602 displays a next journal representation, and a bottom portion of the journal navigation menu 602 displays a previous journal representation.

At 804, an interactive page in a sequence of interactive pages of a selected journal is displayed on the other of the first or second display device. For example, while the navigation menu 602 is displayed on the first display device 104, the navigation manager 134 causes display of an interactive page 604 of the selected journal on the second display device 106.

At 806, navigation through selectable representations of multiple journals is enabled via user input to the journal navigation menu. For example, navigation manager 134 enables navigation through the selectable representations of the journals via user input to the journal navigation menu 602. In some cases, the navigation manager 134 enables navigation through the selectable representations of the multiple journals in the journal navigation menu 602 responsive to a first set of user gestures (e.g., swiping up or down), and enables navigation through interactive pages of a selected journal in response to a second set of gestures (e.g., swiping left or right). The navigation manager 134 may enable the user to access the journal navigation menu 602 at any time, such as by displaying the navigation menu in response to the user swiping up or down on the display device or by clicking a button on a stylus. Thus, the navigation manager 134 enables the user to quickly and easily switch between multiple different journals maintained by the journal application 133.

FIG. 9 illustrates an example system generally at 900 that includes an example computing device 902 that is representative of one or more computing systems and/or devices that may implement the various techniques described herein. In at least some implementations, the computing device 902 represents an implementation of the client device 102 discussed above. The computing device 902 may, for example, be configured to assume a mobile configuration through use of a housing formed and sized to be grasped and carried by one or more hands of a user, illustrated examples of which include a mobile phone, mobile game and music device, and tablet computer although other examples are also contemplated. In at least some implementations, the client device 102 may be implemented as a wearable device, such as a smart watch, smart glasses, a dual-surface gesture-input peripheral for a computing device, and so forth.

The example computing device 902 as illustrated includes a processing system 904, one or more computer-readable media 906, and one or more I/O interface 908 that are communicatively coupled, one to another. Although not shown, the computing device 902 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 904 is representative of functionality to perform one or more operations using hardware. Accordingly, the processing system 904 is illustrated as including hardware element 910 that may be configured as processors, functional blocks, and so forth. This may include implementation in hardware as an application specific integrated circuit or other logic device formed using one or more semiconductors. The hardware elements 910 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 906 is illustrated as including memory/storage 912. The memory/storage 912 represents memory/storage capacity associated with one or more computer-readable media. The memory/storage component 912 may include volatile media (such as random access memory (RAM)) and/or nonvolatile media (such as read only memory (ROM), Flash memory, optical disks, magnetic disks, and so forth). The memory/storage component 912 may include fixed media (e.g., RAM, ROM, a fixed hard drive, and so on) as well as removable media (e.g., Flash memory, a removable hard drive, an optical disc, and so forth). The computer-readable media 906 may be configured in a variety of other ways as further described below.

Input/output interface(s) 908 are representative of functionality to allow a user to enter commands and information to computing device 902, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 902 may be configured in a variety of ways to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 902. By way of example, and not limitation, computer-readable media may include “computer-readable storage media” and “computer-readable signal media.”

“Computer-readable storage media” may refer to media and/or devices that enable persistent storage of information in contrast to mere signal transmission, carrier waves, or signals per se. Thus, computer-readable storage media refers to non-signal bearing media and does not include signals per se. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 902, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 910 and computer-readable media 906 are representative of modules, programmable device logic and/or fixed device logic implemented in a hardware form that may be employed in some implementations to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 910. The computing device 902 may be configured to implement particular instructions and/or functions corresponding to the software and/or hardware modules. Accordingly, implementation of a module that is executable by the computing device 902 as software may be achieved at least partially in hardware, e.g., through use of computer-readable storage media and/or hardware elements 910 of the processing system 904. The instructions and/or functions may be executable/operable by one or more articles of manufacture (for example, one or more computing devices 902 and/or processing systems 904) to implement techniques, modules, and examples described herein.

Example implementations described herein include, but are not limited to, one or any combinations of one or more of the following examples:

In one or more examples, a dual-display device comprises: a left display device and a right display device; at least one processor; and at least one computer-readable storage media storing instructions that are executable by the at least one processor to: cause display of a first interactive page in a sequence of interactive pages of a journal application on the left display device and cause display of a second interactive page in the sequence of interactive pages of the journal application on the right display device; and manage navigation through the interactive pages of the journal application using single-page navigation.

An example as described alone or in combination with any of the other examples described above or below, wherein the single-page navigation causes forward navigation by moving the second page in the sequence of interactive pages of the journal application from the right display device to the left display device, and causing display of a next interactive page in the sequence of interactive pages of the journal application on the right display device.

An example as described alone or in combination with any of the other examples described above or below, wherein the single-page navigation causes backward navigation by moving the first page in the sequence of interactive pages of the journal application from the left display device to the right display device, and causing display of a previous interactive page in the sequence of interactive pages of the journal application on the left display device.

An example as described alone or in combination with any of the other examples described above or below, further comprising instructions that are executable by the at least one processor to manage interactive pages of the journal application in a journal layer and manage applications executed on the dual-display device in an application layer that is separate from the journal layer.

An example as described alone or in combination with any of the other examples described above or below, wherein the application layer overlays the journal layer.

An example as described alone or in combination with any of the other examples described above or below, wherein a positioning of an application relative to the left or right display device remains fixed during navigation through the interactive pages of the journal application.

An example as described alone or in combination with any of the other examples described above or below, further comprising instructions that are executable by the at least one processor to enable an object to be moved from an application to an interactive page.

An example as described alone or in combination with any of the other examples described above or below, wherein the journal application maintains multiple different journals.

An example as described alone or in combination with any of the other examples described above or below, further comprising instructions that are executable by the at least one processor to enable navigation through the different journals in response to a first set of user gestures, and enable navigation through interactive pages of a selected journal in response to a second set of gestures.

An example as described alone or in combination with any of the other examples described above or below, wherein the left display device and the right display device are physically connected to each other by a hinge.

In one or more examples, a method implemented by a computing device comprises: causing display of a first interactive page in a sequence of interactive pages of a journal application on a left display device and causing display of a second interactive page in the sequence of interactive pages of the journal application on a right display device; and manage navigation forward and backward through the interactive pages of the journal application using single-page navigation, the single page navigation comprising: causing forward navigation by moving the second page in the sequence of interactive pages of the journal application from the right display device to the left display device, and causing display of a next interactive page in the sequence of interactive pages of the journal application on the right display device; and causing backward navigation by moving the first page in the sequence of interactive pages of the journal application from the left display device to the right display device, and causing display of a previous interactive page in the sequence of interactive pages of the journal application on the left display device.

An example as described alone or in combination with any of the other examples described above or below, further comprising managing interactive pages of the journal application in a journal layer and managing applications executed on the dual-display device in an application layer that overlays the journal layer.

An example as described alone or in combination with any of the other examples described above or below, wherein a positioning of an application relative to the left or right display device remains fixed during navigation through the interactive pages of the journal application.

In one or more examples, a dual-display device comprises: a first display device and a second display device; at least one processor; and at least one computer-readable storage media storing instructions that are executable by the at least one processor to: cause display of a journal navigation menu on one of the first or second display devices, the journal navigation menu comprising selectable representations of multiple journals of a journal application; cause display of an interactive page in a sequence of interactive pages of a selected journal on the other of the first or second display devices; and enable navigation through the selectable representations of multiple journals via user input to the journal navigation menu.

An example as described alone or in combination with any of the other examples described above or below, wherein: a middle portion of the journal navigation menu displays a selected journal representation; a top portion of the journal navigation menu displays a next journal representation; and a bottom portion of the journal navigation menu displays a previous journal representation.

An example as described alone or in combination with any of the other examples described above or below, further comprising instructions that are executable by the at least one processor to: cause navigation through the multiple journals in response to a first set of gestures; and cause navigation through multiple interactive pages of the selected journal in response to a second set of gestures that are different than the first set of gestures.

An example as described alone or in combination with any of the other examples described above or below, wherein the first set of gestures comprises swiping up or down on the journal navigation menu, and wherein the second set of gestures comprises swiping left or right on the interactive page of the selected journal.

An example as described alone or in combination with any of the other examples described above or below, wherein the journal navigation menu is displayed on a left display device of the dual-display device, and wherein the interactive page of the selected journal is displayed on a right display device of the dual-display device.

An example as described alone or in combination with any of the other examples described above or below, wherein user input to navigate to a next interactive page in the sequence of interactive pages of the journal application causes the interactive page of the selected journal to replace the journal navigation menu on the left display device and causes the next interactive page in the sequence of interactive pages of the journal application to be displayed on the right display device.

An example as described alone or in combination with any of the other examples described above or below, further comprising instructions that are executable by the at least one processor to manage navigation through interactive pages of the selected journal using single-page navigation.

Although the example implementations have been described in language specific to structural features and/or methodological acts, it is to be understood that the implementations defined in the appended claims is not necessarily limited to the specific features or acts described. Rather, the specific features and acts are disclosed as example forms of implementing the claimed features.

What is claimed is:

1. A dual-display device comprising:
a left display device and a right display device;
at least one processor; and
at least one computer-readable storage media storing instructions that are executable by the at least one processor to:
cause display of a first interactive page in a sequence of interactive pages of a journal application on the left display device and cause display of a second interactive page in the sequence of interactive pages of the journal application on the right display device; and
manage navigation through the interactive pages of the journal application using single-page navigation.

2. The dual-display device of claim 1, wherein the single-page navigation causes forward navigation by moving the second page in the sequence of interactive pages of the journal application from the right display device to the left display device, and causing display of a next interactive page in the sequence of interactive pages of the journal application on the right display device.

3. The dual-display device of claim 1, wherein the single-page navigation causes backward navigation by moving the first page in the sequence of interactive pages of the journal application from the left display device to the right display device, and causing display of a previous interactive page in the sequence of interactive pages of the journal application on the left display device.

4. The dual-display device of claim 1, further comprising instructions that are executable by the at least one processor to manage interactive pages of the journal application in a journal layer and manage applications executed on the dual-display device in an application layer that is separate from the journal layer.

5. The dual-display device of claim 5, wherein the application layer overlays the journal layer.

6. The dual-display device of claim 1, wherein a positioning of an application relative to the left or right display device remains fixed during navigation through the interactive pages of the journal application.

7. The dual-display device of claim 1, further comprising instructions that are executable by the at least one processor to enable an object to be moved from an application to an interactive page.

8. The dual-display device of claim 1, wherein the journal application maintains multiple different journals.

9. The dual-display device of claim 8, further comprising instructions that are executable by the at least one processor to enable navigation through the multiple different journals in response to a first set of user gestures, and enable navigation through interactive pages of a selected journal in response to a second set of gestures.

10. The dual-display device of claim 1, wherein the left display device and the right display device are physically connected to each other by a hinge.

11. A method implemented by a dual-display device comprising a left display device and a right display device, the method comprising:
causing display of a first interactive page in a sequence of interactive pages of a journal application on the left display device and causing display of a second interactive page in the sequence of interactive pages of the journal application on the right display device; and
manage navigation forward and backward through the interactive pages of the journal application using single-page navigation, the single page navigation comprising:
causing forward navigation by moving the second page in the sequence of interactive pages of the journal application from the right display device to the left display device, and causing display of a next interactive page in the sequence of interactive pages of the journal application on the right display device; and
causing backward navigation by moving the first page in the sequence of interactive pages of the journal application from the left display device to the right display device, and causing display of a previous interactive page in the sequence of interactive pages of the journal application on the left display device.

12. The method of claim 11, further comprising managing interactive pages of the journal application in a journal layer and managing applications executed on the dual-display device in an application layer that overlays the journal layer.

13. The method of claim 11, wherein a positioning of an application relative to the left or right display device remains fixed during navigation through the interactive pages of the journal application.

14. A dual-display device comprising:
a first display device and a second display device;
at least one processor; and
at least one computer-readable storage media storing instructions that are executable by the at least one processor to:
cause display of a journal navigation menu on one of the first or second display devices, the journal navigation menu comprising selectable representations of multiple journals of a journal application;
cause display of an interactive page in a sequence of interactive pages of a selected journal on the other of the first or second display devices; and
enable navigation through the selectable representations of multiple journals via user input to the journal navigation menu.

15. The dual-display device of claim 14, wherein:
a middle portion of the journal navigation menu displays a selected journal representation;
a top portion of the journal navigation menu displays a next journal representation; and
a bottom portion of the journal navigation menu displays a previous journal representation.

16. The dual-display device of claim 14, further comprising instructions that are executable by the at least one processor to:
cause navigation through the multiple journals in response to a first set of gestures; and
cause navigation through multiple interactive pages of the selected journal in response to a second set of gestures that are different than the first set of gestures.

17. The dual-display device of claim 16, wherein the first set of gestures comprises swiping up or down on the journal navigation menu, and wherein the second set of gestures comprises swiping left or right on the interactive page of the selected journal.

18. The dual-display device of claim 14, wherein the journal navigation menu is displayed on a left display device of the dual-display device, and wherein the interactive page of the selected journal is displayed on a right display device of the dual-display device.

19. The dual-display device of claim 18, wherein user input to navigate to a next interactive page in the sequence of interactive pages of the journal application causes the interactive page of the selected journal to replace the journal navigation menu on the left display device and causes the next interactive page in the sequence of interactive pages of the journal application to be displayed on the right display device.

20. The dual-display device of claim 14, further comprising instructions that are executable by the at least one processor to manage navigation through interactive pages of the selected journal using single-page navigation.
